(19) United States
(12) Patent Application Publication
(10) Pub. No.: US 2023/0285910 A1
(43) Pub. Date: Sep. 14, 2023

(54) CELLULOSE MEMBRANE AND METHOD OF MANUFACTURING SAME

(71) Applicant: The Research Foundation for the State University of New York, Albany, NY (US)

(72) Inventors: Mengying Yang, Port Washington, NY (US); Benjamin S. Hsiao, Setauket, NY (US)

(21) Appl. No.: 18/120,470

(22) Filed: Mar. 13, 2023

Related U.S. Application Data
(60) Provisional application No. 63/319,567, filed on Mar. 14, 2022.

(51) Int. Cl. B01D 71/10; B01J 20/24; B01J 20/28; B01J 20/30; B01D 69/02; B01D 69/12; C02F 1/44; B01D 67/00

(52) U.S. Cl. CPC B01D 71/10; B01D 67/0002; B01D 67/00933; B01D 69/02; B01D 69/1214; B01J 20/24; B01J 20/28004; B01J 20/28035; B01J 20/28038; B01J 20/3007; B01J 20/3085; C02F 1/44; B01D 2323/081; B01D 2323/30; B01D 2325/0281; B01D 2325/04; B01D 2325/20; B01D 2325/40

(57) ABSTRACT

The present disclosure provides a nanostructured cellulose membrane system with high porosity, and methods for making same. The cellulose membrane system includes carboxylate-functionalized cellulose nanofibers combined with a cellulose microfiber scaffold, which are attached by a crosslinking reaction between the nanofibers and/or between the nanofibers and the microfiber scaffold.

### CROSS REFERENCE TO RELATED APPLICATIONS

This application claims the benefit of, and priority to, U.S. Provisional Pat. Application Serial No. 63/319,567, filed Mar. 14, 2022, the entire disclosure of which is incorporated by reference herein.

### GOVERNMENT RIGHTS

This invention was made with government support under DMR-1808690 awarded by the National Science Foundation. The government has certain rights in the invention.

### BACKGROUND

Separation processes are important in many industries. Membrane separation technology has been widely adapted in many separation processes due to its broad range of advantages, including lower energy and chemical consumption, and easier operation and maintenance. These processes include water purification, desalination, air filtration/separation, etc.

Membranes used for filtration should have certain desirable properties. For example, a greater volume of material to be filtered, sometimes referred to as throughput, is one desirable property. The ability to remove contaminants, sometimes referred to as selectivity, is another desirable property. Reducing the clogging of the membranes, so that the fouling of the membranes is low and requires less frequent cleaning and/or the use of harsh chemicals or processes for cleaning, is yet another desirable property.

Improved membranes and methods for forming membranes, as well as uses thereof, remain desirable.

### SUMMARY

The present disclosure provides novel cellulose membranes and methods for making same. In embodiments, a membrane system of the present disclosure includes a microfiber scaffold including cellulose and carboxylate-functionalized cellulose nanofibers.

In embodiments, the microfiber scaffold of the membrane system has a porosity from about 70% to about 90%. In other embodiments, the microfiber scaffold of the membrane system has a porosity from about 75% to about 85%.

In embodiments, the microfiber scaffold has a thickness from about 110 µm to about 160 µm. In some embodiments the microfiber scaffold has a thickness from about 115 µm to about 155 µm.

In embodiments, the carboxylate-functionalized cellulose nanofibers are infused within the microfiber scaffold, the carboxylate-functionalized cellulose nanofibers are coated on the microfiber scaffold, or both.

In embodiments, the carboxylate-functionalized cellulose nanofibers are crosslinked with the microfiber scaffold.

In some embodiments, the carboxylate-functionalized cellulose nanofibers are present in an amount from about 0.1% by weight to about 2.5% by weight of the membrane system.

In embodiments, the membrane system has a porosity from about 70% to about 90%. In other embodiments, the membrane system has a porosity from about 75% to about 85%.

In some embodiments, the membrane system has a permeation flux from about 7.3 L m⁻² h⁻¹ bar-¹ to about 10.3 L m⁻² h⁻¹ bar⁻¹.

Methods for using the membrane system for filtering water, include contacting water with the membrane system.

Methods for producing the membrane system are also provided. In embodiments, such a method includes combining a microfiber scaffold including cellulose with carboxylate-functionalized cellulose nanofibers to form a suspension; mixing the suspension; filtering the suspension to form a membrane; recovering the membrane; and contacting the membrane with a crosslinking agent, wherein the carboxylate-functionalized cellulose nanofibers are crosslinked with the microfiber scaffold and the microfiber scaffold is infused with the carboxylate-functionalized cellulose nanofibers, coated with the carboxylate-functionalized cellulose nanofibers, or both.

In embodiments, mixing the suspension occurs by stirring at a rate from about 700 rpm to about 1100 rpm for a period of time from about 15 minutes to about 45 minutes.

In some embodiments, filtering the suspension to form the membrane occurs by gravity filtration for a period from about 1 day to about 5 days.

In embodiments, the crosslinking agent includes polyamideamine-epichlorohydrin.

In embodiments, contacting the membrane with the crosslinking agent occurs by immersing the membrane in the crosslinking agent for a period of time from about 15 minutes to about 45 minutes. In some embodiments, the method for producing the membrane system further includes, after contacting the membrane with the crosslinking agent, curing the membrane at a temperature from about 110° C. to about 130° C., for a period of time from about 15 minutes to about 45 minutes.

In other embodiments, the method for producing the membrane system further includes, after curing the membrane, washing the membrane with distilled water and then drying the membrane.

### BRIEF DESCRIPTION OF THE DRAWINGS

Various embodiments of the presently disclosed membranes and methods are described herein with reference to the drawings wherein:

FIG. 1 depicts crosslinking reactions used to form membrane systems in accordance with the present disclosure, which includes PAE-CNF crosslinking and PAE-PAE self-crosslinking.

FIG. 2 depicts methods for preparing cellulose membranes in accordance with the present disclosure, including photographs and SEM images of a 50-0.85 crosslinked membrane (i.e., 50 g m⁻² Lyocell and 0.85 g m⁻² CNF).

FIGS. 3 provides data characterizing all-cellulose membranes of the present disclosure with different CNF loading contents with and without crosslinking. FIG. 3A includes FTIR spectra and FIG. 3B includes XRD patterns of the CNF, Lyocell, and cellulose membranes with and without PAE crosslinking (0.1 wt%). FIG. 3C includes a graph of the zeta potential analysis of 0.1 wt% PAE crosslinked (CL) and non-crosslinked (No CL) cellulose membranes (50-0.85) as a function of the pH value. FIG. 3D depicts membrane pore size (determined by 90% rejection ratio of PS nanoparticles with the smallest size. FIG. 3E depicts membrane PS solution water flux and 50 nm PS nanoparticles rejection ratio with increasing CNF loading amount (the dry mass of Lyocell was 50 g m-2). FIG. 3F depicts porosity of cellulose membranes crosslinked with 0.1 wt% PAE. Data are presented as the mean value (mean ± SD of n=3 repeating tests).

FIG. 4 are SEM images showing surface morphology of all-cellulose membranes of the present disclosure. FIGS. 4A and 4B show the 50-0.0 (i.e., pure Lyocell) CL membrane, and FIGS. 4C and 4D show the 50-1.0 (Lyocell/CNF) CL membrane. FIGS. 4E and 4F show cross-sectional morphology of the 50-0.85 CL membrane. FIGS. 4G and 4H show surface morphology of the 50-0.85 CL membrane after the PS nanoparticles (50 nm) filtration. All the membranes tested were crosslinked with 0.1% PAE.

FIGS. 5 provides stress-strain curves and calculated toughness of dry (FIGS. 5A and 5C), and wet (FIGS. 5B, and 5D) cellulose membranes with and without crosslinking (0.1 wt % PAE). FIG. 5E is a comparison of the maximum wet stress values of cellulose membranes (crosslinked with 0.1 wt % PAE) with those of other reported membranes. FIG. 5F shows the maximum wet stress change from a 14-day wet immersion test of the CL 50-0.85 membrane. Bars represent the mean values ± SD based on three independent tests.

FIGS. 6 shows the wastewater filtration performance of all-cellulose and commercial membranes. FIG. 6A shows the filtration cycles with multiple permeation flux recoveries for cellulose (CL 50-0.85), PVDF-V6 (modified PVDF), PVDF-A6, and PES-LX membranes using alternative hydraulic wash and NaClO wash. FIG. 6B shows the total dissolved solid (TDS -columns) and turbidity (symbols) changes in wastewater filtration. FIG. 6 C shows the water flux recovery ratio and rejection ratio of cellulose (CL 50-0.85), PVDF-V6, PVDF-A6, and PES-LX membranes after hydraulic and NaClO cleaning. Data are presented as mean ± SD of n=3 repeats.

FIGS. 7 provides characterization data of membranes of the present disclosure before and after wastewater filtration. FIG. 7A is an FT-IR spectra, FIG. 7B depicts membrane zeta potential (pH = 7; 1 mM KCl), and FIG. 7C shows the water contact angle of the pristine, wastewater fouled, and NaClO cleaned membranes (the chosen cellulose membrane was CL 50-0.85). Bars are presented as mean ± SD of n=3 individual tests.

FIGS. 8 depicts the results of a mechanism study of membrane fouling by calculating the fouling resistances parameters and fitting with CFCBM, CFIBM, and CFSBM models. FIG. 8A is a summary of the total resistance (Rₜ), inherent membrane resistance (R_{M}) and fouling resistance (R_{f}), FIG. 8B shows the reversible fouling ratio (R_{c/}R_{f}) and irreversible fouling ratio (R_{p/}R_{f}) of cellulose and polymeric membranes during the flux recovery experiment of wastewater filtration. FIGS. 8C-8F show experimental and predictive permeation volume as a function of filtration time among different combined models of cellulose (CL 50-0.85), PVDF-V6, PVDF-A6, and PES-LX membranes. Bars are presented as mean ± SD of n=3 individual tests.

FIGS. 9 shows the reproducibility and durability test of cellulose membranes of the present disclosure. FIG. 9A shows the ratio of permeation water flux (J_{w}) over initial water flux (Jₒ), and FIG. 9B shows the flux recovery ratio and turbidity rejection ratio over 16-cycle wastewater runs of CL 50-0.85 membrane. FIG. 9C shows the long term wastewater filtration of CL 50-0.85 membrane using the immersed membrane filtration system and the corresponding rejection ratio in terms of the turbidity. FIG. 9D shows the results of a durability test of the CL 50-0.85 membrane evaluated regarding two critical pH values (immersed in pH = 2.5 and 9.0 buffer solutions for three days) and temperature (immersed in 60° C. warm water for 7 days) resistance. Bars presented the permeation flux data, and the symbols presented the turbidity data (mean ± SD of n=3 independent tests).

FIGS. 10 demonstrates the self-healing property of all-cellulose membrane. FIG. 10A shows the results of a scratch test of the disclosed cellulose (CL 50-0.85) and polymeric membranes regarding the distilled water filtration. FIG. 10B shows the results of a scratch test of cellulose membranes of the present disclosure (CL 50-0.85) regarding the wastewater filtration performance and permeate turbidity during cyclic operation with hydraulic cleaning. FIG. 10C is a SEM image of the self-healed cellulose membrane after the scratch test of distilled water filtration.

### DETAILED DESCRIPTION

The following detailed description of embodiments of the subject matter of the present disclosure will be made in reference to the accompanying drawings. In describing the disclosure, explanation about related functions or constructions known in the art are omitted for the sake of clearness in understanding the concept of the present disclosure to avoid obscuring the recited subject matter with unnecessary detail.

The present disclosure provides a cellulose membrane system and method of manufacturing same for wastewater treatment with low fouling using 100% sustainable cellulose manufactured by an energy-saving method.

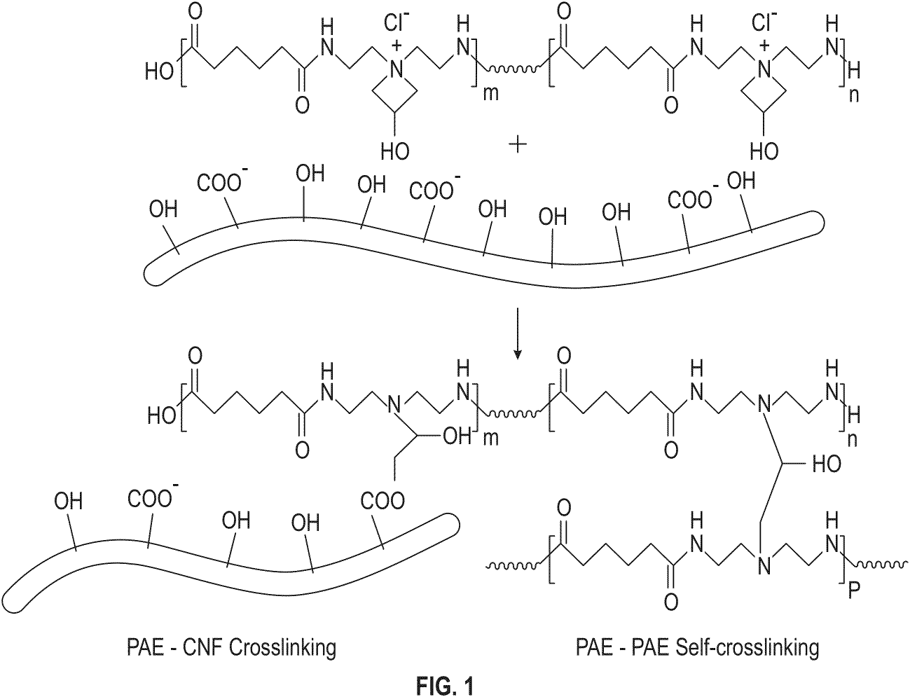

All-cellulose membranes, developed entirely from natural biomass resources, have untapped potentials for a wide range of water purification applications, including wastewater treatment. As described herein, water-resistant and super hydrophilic all-cellulose membranes with high porosity (~80%) are provided, as well as the use of these membranes in wastewater treatment. The demonstrated membrane system includes a microfiber scaffold infused with and/or coated with a layer of carboxylated cellulose nanofibers, also referred to herein as carboxylate-functionalized cellulose nanofibers (“CNFs”). In embodiments, the CNFs may be crosslinked by a suitable crosslinker, in embodiments polyamideamine-epichlorohydrin (PAE). (See, e.g., FIG. 1.)

In embodiments, any suitable cellulosic material may be used to form the microfiber scaffold of the membrane of the present disclosure. In some embodiments, Lyocell, a commercially available regenerated cellulose microfiber (obtained from Engineered Fibers Technology Company), may be used to form the microfiber scaffold. Lyocell may be formed by first dissolving grade wood pulp and mixing with N-methylmorpholine-N-oxide (NMMO) solvent to yield a clear viscous solution. The solution thus produces is then filtered and spun into dilute NMMO, whereupon the cellulose fibers precipitate, followed by washing and drying processes, and the resulting Lyocell material is obtained.

The microfiber scaffold used in forming the membrane of the present disclosure may have a porosity of from about 70% to about 90%, in embodiments from about 75% to about 85%, in embodiments about 80%. The microfiber scaffold may have a thickness from about 110 µm to about 160 µm, in embodiments from about 115 µm to about 155 µm.

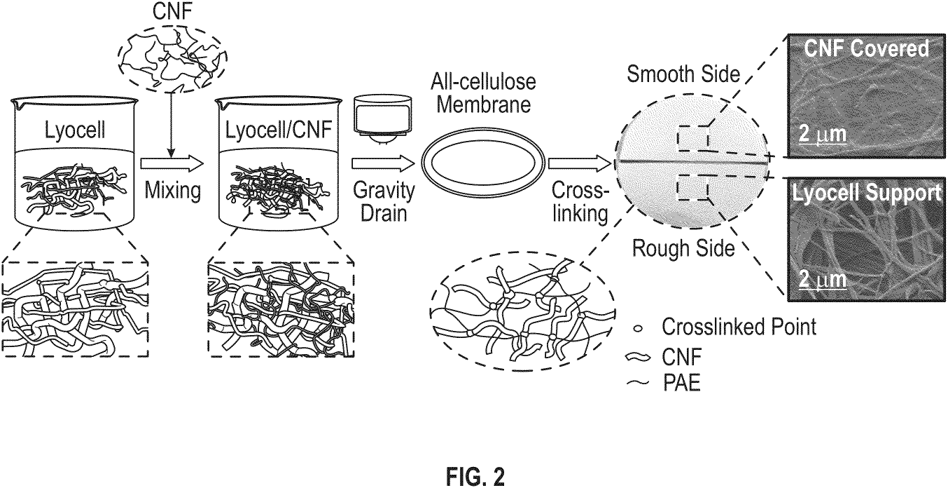

As noted above, membranes of the present disclosure also include carboxylated CNFs. The carboxylated CNFs are extracted from any raw or untreated biomass using a TEMPO-oxidation method. (See, FIG. 2.) Suitable methods for forming such CNFs include those disclosed in U.S. Pat. No. 11,235,290, the entire disclosure of which is incorporated by reference herein.

For example, in embodiments, suitable oxidation procedures to generate nanofibers, in embodiments, polysaccharide nanofibers, include the following. A 2,2,6,6-tetramethylpiperidine-1-oxyl (TEMPO)/NaBr/NaClO oxidation system may be used to generate carboxylate groups on the surface of the cellulose nanofibers. For example, the C6-hydroxyl group is oxidized to a certain degree with this oxidation system. After oxidation, both carboxylate and aldehyde groups may be produced, in addition to the original hydroxyl groups. After mild mechanical treatment (e.g., stirring or mixing with a homogenizer at a speed of 5000 rpm), cellulose nanofibers having a large number of carboxylate groups are produced.

Carboxylated cellulose nanofibers (CN-COONa) may be prepared by dispersing dry wood pulp cellulose in water. Sodium bromide and TEMPO agent are then dissolved in the suspension. The reaction is initiated by adding NaClO aqueous solution. The mixture may be stirred for a suitable period of time at room temperature with the pH value maintained from about 9 to about 11 (adjusted using sodium hydroxide aqueous solution). The reaction is terminated by adding ethanol followed by stirring. The oxidized cellulose product is separated using centrifugation and subsequently washed with deionized (DI) water. This process may be repeated several times until the pH value is close to neutral.

Other suitable methods for forming carboxylated CNFs include those disclosed in U.S. Pat. No. 10,894,838, the entire disclosure of which is incorporated by reference herein.

Briefly, a simple two-chemical method may be used to form the carboxylated CNFs. This method includes contacting the raw biomass of lignocellulose wood or non-wood sources, including agricultural residues, phytoplanktons, algal celluloses, tunicate celluloses, and/or animal celluloses, including bacterial celluloses, with an acid component and an oxidizing agent. In embodiments, the acid component includes nitric acid (HNO3). Nitric acid may be used by itself as the acid component, or may be combined with an additional acid. Suitable additional acids which may be used with nitric acid as the acid component include, in embodiments, hydrochloric acid (HCI), sulfuric acid (H2SO4), acetic acid (CH3COOH), hydrobromic acid (HBr), hydrofluoric acid (HF) and combinations thereof. The acid component, which may be nitric acid or a combination of nitric acid with one of the other foregoing acids, may be at a concentration from about 10 mmol to about 300 mmol, in embodiments from about 20 mmol to about 250 mmol.

Suitable oxidizing agents include, in embodiments, nitrite salts, nitrate salts, and combinations thereof. Suitable nitrite salts and nitrate salts include, for example, sodium nitrite (NaNO2), potassium nitrite (KNO2), calcium nitrite (Ca(NO2) 2), magnesium nitrite (Mg(NO2) 2), lithium nitrite (LiNO2), ammonium nitrite (NH4NO2), nitrite esters, sodium nitrate (NaNO3), potassium nitrate (KNO3), calcium nitrate (Ca(NO3) 2), magnesium nitrate (Mg(NO3) 2), lithium nitrate (LiNO3), ammonium nitrate (NH4NO3), nitrate esters, and/or combinations of these nitrite salts and nitrate salts. The oxidizing agent may be at a concentration from about 0.1 mmol to about 60 mmol, in embodiments from about 10 mmol to about 30 mmol.

The plant biomass is chopped or otherwise reduced in size and then treated with an acid as described above to wet the plant biomass. In some embodiments, the plant biomass may be washed with acetone, water, sodium hydroxide, potassium hydroxide, ethyl acetate, ethanol, and combinations thereof, prior to addition of the acid. The oxidizing agent(s), such as a nitrite salt described above, is then added thereto, and the materials are held at a temperature from about 25° C. to about 100° C., in embodiments from about 40° C. to about 60° C.

The process can be completed in a short time period, in embodiments from about 30 minutes to about 72 hours, in other embodiments from about 3 hours to about 12 hours, without the aid of mechanical treatments.

The dimensions of the carboxycellulose nanofibers produced by this method have a fiber length (L) equal to or less than 1000 nm, in embodiments from about 50 to about 1000 nm, in other embodiments from about 150 nm to about 900 nm.

The carboxycellulose nanofibers produced by this method have a nominal diameter (D) from about 2 nm to about 20 nm, in embodiments from about 3 nm to about 10 nm.

The resulting carboxycellulose or carboxylated celluloses nanofibers have a carboxy content from about 5% to about 30%, in embodiments from about 10% to about 25%, and may have aldehyde content from 0-2%. The resulting carboxycellulose nanofibers have a lignin content from about 1% by weight to about 15% by weight, in embodiments from about 2% by weight to about 10% by weight.

The resulting membrane system may include the carboxylate-functionalized cellulose nanofibers in an amount from about 0.1 % by weight to about 2.5% by weight of the membrane system, in embodiments from about 0.5 % by weight to about 2.0% by weight of the membrane system.

A process for forming the membrane system of the present disclosure includes combining the material to form the microfiber scaffold with the CNFs to form a suspension, mixing the two together, and then filtering the materials to form a non-crosslinked cellulose membrane. The non-crosslinked membrane is then contacted with a crosslinking agent capable of crosslinking cellulose, whereby the microfiber scaffold is coated with the CNFs and/or the CNFs are infused within the microfiber scaffold.

Any crosslinking agent capable of crosslinking the CNFs and the microfiber scaffold may be used. In aspects, a suitable crosslinker is one which will crosslink cellulose. For example, as noted above, in embodiments CNFs may be reacted with an epichlorohydrin, in embodiments polyamideamine-epichlorohydrin (PAE). (See, e.g., FIG. 1.) As depicted in FIG. 1, the PAE reacts with the CNFs, as well as crosslinking between PAE itself. The use of such a crosslinker permits crosslinking of the CNFs with each other, as well as with the microfiber scaffold, thereby forming a CNF coating on the microfiber scaffold and/or infusion of the CNFs within the microfiber scaffold.

Alternatively, the CNFs may be separately applied to the microfiber scaffold. The CNFs may be combined with the crosslinker and react therewith as depicted in FIG. 1. Crosslinking between CNFs may occur. The CNFs having reacted with the PAE may include unreacted portions of PAE which, in turn, may then react with the cellulosic microfiber scaffold to become adhered to a surface thereof as a coating thereon, and/or infused within pores of the microfiber scaffold.

As noted above, the use of such a crosslinker permits crosslinking of the CNFs, and crosslinking of the CNFs with the microfiber scaffold, thereby providing a mechanism for attaching the CNFs to the microfiber scaffold of the membrane system, either by infusion of the CNFs within the microfiber scaffold and/or a coating thereon.

In some embodiments, a general process for forming the membrane system of the present disclosure includes the following. A suspension of CNF extracted from a suitable cellulosic source may be prepared according to the TEMPO-oxidation protocol described above in U.S. Pat. No. 11,235,290 and/or U.S. Pat. No. 10,894,838, the entire disclosures of which are incorporated by reference herein. Other suitable methods for forming this CNF suspension include the TEMPO-oxidation protocol described in the literature. Isogai, et al., TEMPO-oxidized cellulose nanofibers, Nanoscale, 3 (2011) 71-85; Yang, et al., Antifouling nanocellulose membranes: How subtle adjustment of surface charge lead to self-cleaning property, J Membrane Sci, 618 (2021) 118739, the entire disclosures of which are incorporated by reference herein.

The membrane system may be mixing Lyocell and the CNF to form a suspension, which may be stirred with a magnetic stirring bar at a rate from about 700 rpm to about 1100 rpm, in embodiments from about 800 rpm to about 1000 rpm, for a suitable time, in embodiments from about 15 minutes to about 45 minutes, in embodiments from about 25 minutes to about 35 minutes, in other embodiments for about 30 minutes.

The resulting mixed suspension is then poured onto a wetted hydrophilic filter membrane supported by a ceramic funnel. Any suitable hydrophilic filter membrane may be utilized. In embodiments, a filter formed of PVDF, having an average pore size of about 0.65 µm, may be used. The suspension drains through the filter via gravity filtration for a suitable time, in embodiments from about 1 day to about 5 days, in embodiments from about 2 days to about 4 days, in embodiments about 3 days, until the membrane is totally dried.

The dried membranes may then be peeled off the PVDF filter, and immersed in a suitable crosslinking agent, in embodiments PAE, for a suitable period of time from about in embodiments from about 15 minutes to about 45 minutes, in embodiments from about 25 minutes to about 35 minutes, in other embodiments for about 30 minutes. The membrane is then cured in an oven at a suitable temperature, in embodiments from about 110° C. to about 130° C., in embodiments from about 115° C. to about 125° C., in embodiments 120° C., for a suitable period of time, in embodiments from about 15 minutes to about 45 minutes, in embodiments from about 25 minutes to about 35 minutes, in other embodiments for about 30 minutes.

The resulting membranes may then be washed with distilled water several times to remove unreacted crosslinking agent, and then dried.

As depicted in FIG. 2, the resulting membrane system of the present disclosure includes both a rough side, which is formed of the microfiber scaffold, and a smooth side, which is formed of the crosslinked CNFs.

The abundant hydroxyl groups and negatively charged functional groups (-COO-) on the carboxylated CNFs impart superhydrophilicity and low fouling properties to the resulting all-cellulose membrane, due to the less hydrophilicity/hydrophobicity interaction and electrostatic repulsion between negatively charged membrane surface and protein/polysaccharide foulants in wastewater.

In addition, the swelling of the cellulose materials used to form the membrane of the present disclosure results in a self-healing property of the membrane, which enables permeation flux and rejection ratio of the damaged all-cellulose membrane recovered within 20 minutes after scratching. Thus, the membrane of the present disclosure and methods for using it address two important aspects of the sustainable development of membranes for wastewater treatment.

As noted above, the membrane system of the present disclosure includes a Lyocell microfiber scaffold infused with cellulose nanofibers (CNF) crosslinked by polyamideamine-epichlorohydrin (PAE); where the membrane showed good mechanical strength (wet stress: 3.5 -8.0 Mpa), pH resistance, and stability in hot water. The optimized membrane exhibited high permeation flux of 8.8 ± 1.5 L m⁻² h⁻¹ bar-¹, i.e., 7.3 L m⁻² h⁻¹ bar-¹ to 10.3 L m⁻² h⁻¹ bar⁻¹, excellent separation efficiency (> 99.9%), good flux recovery ratio (> 95%), and self-healing property for wastewater filtration, compared with the commercial polymeric membranes such as polyvinylidene difluoride (PVDF) and polyether sulfone (PES) membranes. Moreover, the fouling mechanism was investigated by the resistance-in-series and three combined cake-filtration models. The membrane provided a highly efficient wastewater treatment filter with superior antifouling performance compared to existing commercial ultrafiltration membranes.

The method provides a low-cost, sustainable, and water-resistant all-cellulose membrane in one-step without pressurization or any usage of organic solvent. The membrane provides superior filtration performance compared to commercially available membranes regarding the permeation flux, flux recovery ratio, low fouling property, and self-healing property.

In addition, the cellulose membrane of the present disclosure is strong and highly hydrophilic, with high porosity (~ 80%), and can be produced in a one-step approach without pressurization or usage of organic solvent. Moreover, the infusion of the cellulose nanofibers in the cellulose-based microfiber scaffold avoid the potential delamination problem which is commonly seen in layer-by-layer coated membranes.

In summary, the membrane and method of manufacture of the present disclosure includes the following advantages:
1. Use of cost-effective carboxylated cellulose nanofiber (CNF) and regenerated cellulose microfibers (Lyocell). Carboxylated CNF is obtained through oxidizing (TEMPO-oxidation) the cheap biomass material like jute fibers. Lyocell fibers have advantages such as their sustainability, easy processing, high strength. In addition, Lyocell has been widely applied in nonwovens and paper production.
2. The membranes may be prepared in a one-step process without pressurization or any usage of organic solvent. The all-cellulose membrane of the present disclosure is prepared by resting the Lyocell/CNF suspension on a ceramic funnel (or any flat sieve-like apparatus), drained via gravity filtration, and dried in room temperature. The membrane preparation method is simple, solvent-free, and does not need any electronical energy.
3. Superior filtration performance. As described above, the optimized all-cellulose membrane exhibited high permeation flux of 8.8 ± 1.5 L m⁻² h⁻¹ bar-¹, i.e., 7.3 L m⁻² h⁻¹ bar-¹ to 10.3 L m⁻² h⁻¹ bar⁻ ¹, excellent separation efficiency (> 99.9%) in terms of turbidity, good flux recovery ratio (> 95%) and self-cleaning.
4. Stability. The membrane system includes a Lyocell microfiber scaffold infused with cellulose nanofibers (CNF) crosslinked by polyamideamine-epichlorohydrin (PAE); where the system exhibited good mechanical strength (wet stress: 3.5 - 8.0 Mpa), pH resistance (pH 2.5 - 9.0), stability in hot water (60° C.), and no delamination issue.
5. Self-healing property. The all-cellulose membranes have the self-healing properties due to the swelling of cellulose material. For example, the permeation flux and rejection ratio of damaged all-cellulose membrane recovered within 20 minutes after scratching for both pure water and wastewater filtration tests.
6. Flexibility and ductility. All-cellulose membranes have superior flexibility and ductility. When immersed in water, the twisted all-cellulose membrane quickly recovered its original shape without any cracks. This ensures the practical usage of all-cellulose membrane when the membrane needs to be warped, folded, or twisted during manufacturing.

Several embodiments of the disclosure are described below with reference to the following non-limiting Examples. The Examples are intended to be illustrative only and are not intended to limit the scope of the present disclosure. As used herein, “room temperature” refers to a temperature of from about 20° C. to about 30° C. Also, parts and percentages, such as solution percentages, are by weight unless otherwise indicated.

### EXAMPLES

The surface properties, crystallinity, zeta potential, pore size, permeability, and porosity of the cellulose membranes were carefully characterized. To compare the filtration performance, demonstrated membranes and commercially available polymeric UF membranes such as polyvinylidene difluoride (PVDF) and polyether sulfone (PES) membranes, a continuously operating wastewater filtration test was designed and conducted. The membranes before and after fouling as well as cleaned with sodium hypochlorite (NaClO) were further characterized by Fourier-transform infrared spectroscopy (FTIR), contact angle and zeta potential techniques. The resistance-in-series models and three combined cake-filtration models were used to analyze the membrane fouling behavior. In addition, the impact of environmental conditions (e.g., pH and temperature) and physical scratch on the performance of cellulose membranes were also carried out.

The materials used in these examples included untreated jute fibers provided by Toptrans Bangladesh Ltd. in Bangladesh. Chemical reagents: 2,2,6,6-Tetramethyl-1-piperidinyloxy (TEMPO, 98%), sodium bromide (NaBr), sodium hypochlorite (NaClO, 14.5% available chlorine), phosphate buffer (0.025 M, pH 2.5) and sodium bicarbonate buffer (0.05 M, pH 9.0) were purchased from Fisher Scientific. Lyocell nanofibrillated fibers with a fiber diameter between 0.1-0.5 µm were provided by Engineered Fibers Technology (EFT), LLC. Hydrophilic polyvinylidene fluoride (PVDF) membrane filter (Durapore®) with 0.65 µm pore size was purchased from Millipore Sigma Company. Polyamideamine-epichlorohydrin (PAE) resin (Kymene 920A) was purchased from Solenis, LLC. Commercial-grade PVDF-A6 (MWCO: 500 kDa, composed of neat PVDF), PVDF-V6 (MWCO: 500 kDa, composed of PVDF treated to create positive surface charge) and PES-LX (MWCO: 300 kDa, composed of neat PES) membranes were purchased from the Sterlitech Corporation.

### Example 1

A suspension of CNF extracted from jute fibers was prepared according to the TEMPO-oxidation protocol described above in U.S. Pat. No. 11,235,290 and/or U.S. Pat. No. 10,894,838, the entire disclosures of which are incorporated by reference herein. In this Example, the CNF suspension included a suspension of CNF extracted from jute fibers that was prepared according to the TEMPO-oxidation protocol described in the literature. Isogai, et al., “TEMPO-oxidized cellulose nanofibers,” Nanoscale, 3 (2011) 71-85; Yang, et al., “Antifouling nanocellulose membranes: How subtle adjustment of surface charge lead to self-cleaning property,” J Membrane Sci, 618 (2021) 118739, the entire disclosures of which are incorporated by reference herein.

Cellulose membranes containing different ratios of dry mass density (g m⁻²) were prepared using by mixing 0.5 wt% Lyocell and 0.15 wt% CNF (1.60 mmol/g in degree of oxidation, average width was 4.9 ± 1.3 nm) suspensions as follows. First, the pre-weighted Lyocell (50 g m⁻² dry mass density) and CNF (0.5 - 2.5 g m⁻² dry mass density) mixed suspension was stirred rigorously with a magnetic stirring bar for 30 minutes. Then, the mixed suspension was poured evenly onto a wetted hydrophilic PVDF filter membrane (average pore size: 0.65 µm) supported by a ceramic funnel and was drained via gravity filtration for 3 days until the membrane was totally dried.

The cellulose membranes were labeled based on the ratio of Lyocell and CNF in terms of their dry mass density. For example, 50-0.0, 50-0.5, 50-0.75, 50-0.85, and 50-2.5 membranes stand for the membranes prepared with 50 g m⁻² Lyocell and 0.0, 0.5, 0.75, 0.85 and 2.5 g m⁻² CNF, respectively. Later, the dried membranes were peeled off from the PVDF filter, immersed in a crosslinking agent (0.1 wt% PAE) for 30 minutes, and then cured in the oven for another 30 minutes at 120° C. The illustration of the crosslinking reaction (i.e., PAE-CNF crosslinking and PAE-PAE self-crosslinking) pathways and the preparation of cellulose membrane is depicted in FIGS. 1 and 2, respectively. FIG. 1 depicts crosslinking reactions used to form membrane systems in accordance with the present disclosure, which includes PAE-CNF crosslinking and PAE-PAE self-crosslinking. FIG. 2 depicts methods for preparing cellulose membranes in accordance with the present disclosure, including photographs and SEM images of a 50-0.85 crosslinked membrane (i.e., 50 g m⁻² Lyocell and 0.85 g m⁻² CNF).

The resulting membranes were washed with distilled water several times to remove unreacted crosslinking agent, and then dried and stored at 50% humidity and room temperature before the tensile test. For FT-IR and XRD measurements, membrane samples were dried at 50° C. for 30 minutes to minimize the signals from water.

### Example 2

The cellulose membrane of Example 1 was first characterized to assess its surface properties, crystallinity, zeta potential, permeability, pore size and porosity. To investigate how the addition of CNF could influence the pore size of the cellulose membranes, a dead-end filtration test using spherical PS nanoparticles of varying sizes was conducted to determine the pore size of the cellulose membranes. It was seen when the CNF loading in the cellulose membranes increased, the corresponding pore size decreased from 1 µm for the original Lyocell membrane (50-0) to 0.2 µm for the 50-0.75 composite membranes. The pore size value was determined when the membrane exhibited 90% of rejection ratio of the PS nanoparticles with the smallest diameter used. As the effective minimum pore size of the CNF scaffold can be affected by the width of nanofibers and the thickness of the CNF layer, the thickness was first evaluated (or the loading) of the CNF. It was found that when the CNF dry mass was above 0.85 g m⁻², the pore size of the cellulose membranes remained around 0.05 µm. While the rejection ratio against PS nanoparticles (0.05 µm) for the 50-0.85 and 50-2.5 membranes increased slightly from 92% to 96%, respectively. However, the extra loading of CNF dramatically reduced the water flux of the membrane (from 134.8 LMH/bar to 4.4 LMH/bar, i.e., about a decrease of 96.8%) because of the low porosity of the CNF layer (< 20%) due to the dense compaction of the CNF scaffold. From this study, the membrane with the CNF loading of 0.85 g m⁻² appeared to exhibit the optimal filtration performance (i.e., high flux and high rejection ratio). The porosity of the cellulose membrane decreased only slightly with the increasing CNF loading. All cellulose membranes exhibited high porosity (> 80%) because of the highly porous structure of the Lyocell scaffold.

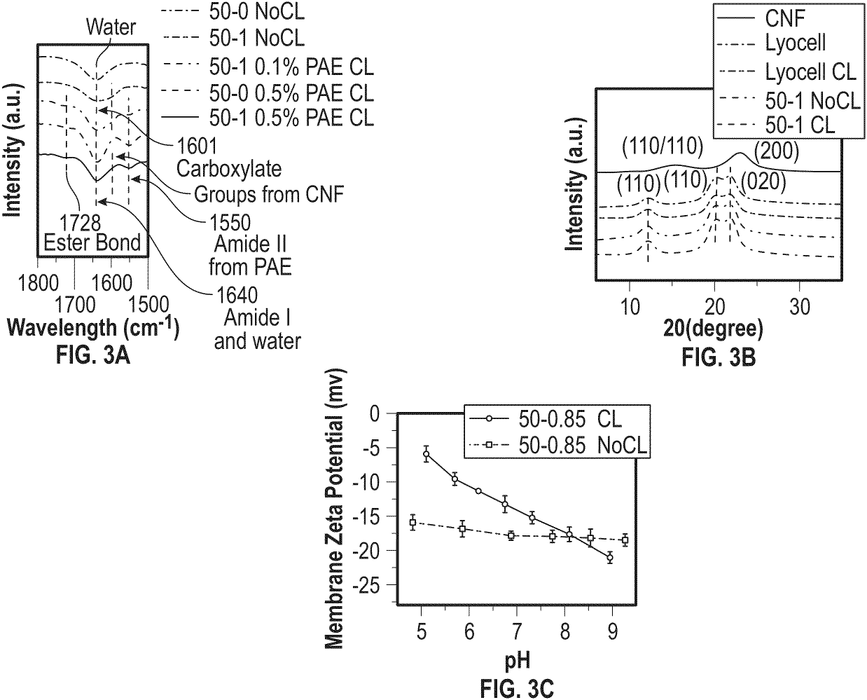

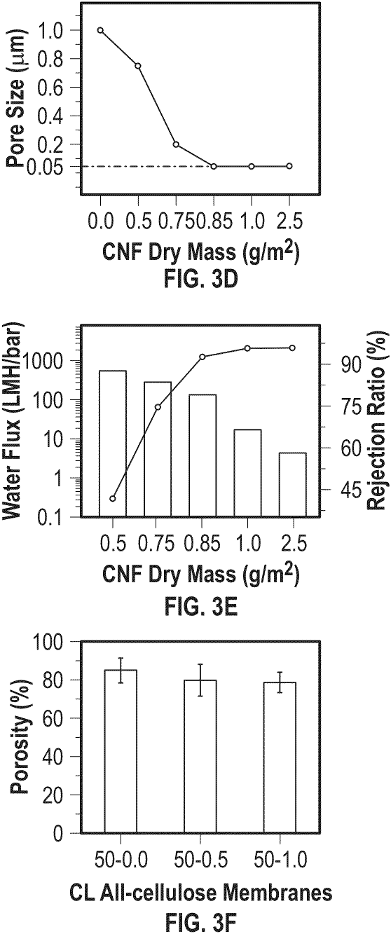

FIGS. 3 A-F include summaries of the characterization results obtained, for the all-cellulose membranes of the present disclosure having different CNF loading contents with and without crosslinking. As can be seen in FIG. 3A, which includes the FT-IR spectra of the cellulose membranes prepared with different CNF dry mass ratios (0.0 - 1.0 g m⁻²) and crosslinking conditions, it was observed that the stretching vibration at 1601 cm⁻¹ of the carboxylate group from CNF was present in all crosslinked and non-crosslinked 50-1.0 (50 g m⁻² Lyocell and 1.0 g m⁻² CNF) membranes. Compared to the neat cellulose membranes, the introduction of PAE resulted in the appearance of two absorption bands: amide I group at 1640 cm⁻¹ and amide II group at 1550 cm⁻ ¹. Due to the adsorbed water in the membrane, the amide I band partly overlapped with the symmetric deformation vibrations of water molecules.

As can be seen in the XRD patterns set forth in FIG. 3B, the crystalline regions in CNF were represented by the diffraction peaks at 2θ = 23.1°, 16.4°, and 14.8°, representing the (200), (110), and (11̅0) lattice planes of the cellulose I structure, respectively. Lyocell is the regenerated cellulose fibers, which showed three diffraction peaks at 2θ = 22.0°, 20.3°, and 12.3°, corresponding to the (020), (110), and (11̅0) lattice planes of the cellulose II structure, respectively. All cellulose membranes illustrated similar diffraction patterns as that of Lyocell fibers because of the small loading amount of CNF (1.0 g m⁻²). It was seen that the crosslinking treatments did not change the crystalline structure of the cellulose I structure because the crosslinking process mainly occurred in the amorphous domains while the crystalline domains of CNF were unaffected.

The crosslinking reaction between CNFs and PAE in the cellulose membrane could also be verified indirectly by the membrane zeta potential measurement. The zeta potential results of non-crosslinked (No CL) and crosslinked (CL) cellulose membranes as a function of pH (in the range of pH = 5-9) are shown in FIG. 3C where all zeta potential values were negative. As can be seen in FIG. 3C, the behavior of the zeta potential change in the cellulose membrane was found to be different due to the presence of PAE. In FIG. 3C, it was seen that the negative charge of the no CL cellulose membrane surface (50 g m⁻² Lyocell and 0.85 g m⁻² CNF membrane) mainly came from the deprotonation of carboxyl groups on CNF, which increased slightly with the pH value resulting in the slight decrease in the membrane zeta potential. However, in the CL cellulose membrane, the deprotonation of the amino groups in PAE could also contribute to the negative zeta potential of the membrane surface, especially with the increase in pH value. This has led to a more pH-dependent zeta potential trend of the CL cellulose membrane.

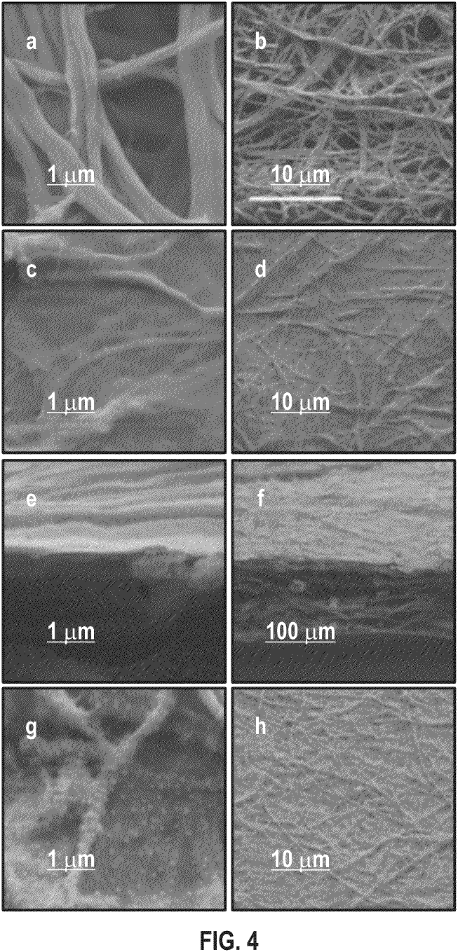

The morphology and nanostructure of cellulose membranes with different CNF loadings (0.0 - 1.0 g m⁻²) were also characterized by SEM, and the results are illustrated in FIG. 4. The surface images of pure Lyocell membrane (crosslinked) showed a highly porous structure defined by the randomly stacked Lyocell microfibers with 0.1-0.5 µm diameters (FIGS. 4A and 4B). With the addition of 0.85 g m⁻² CNF, the membrane surface exhibited a smooth cellulose surface without detectable pore structure, even at the micrometer scale (FIGS. 4C and 4D). The top view and cross-sectional images of the 50-0.85 crosslinked (CL) membrane (FIGS. 4E and 4F, respectively) revealed the hierarchical structure of the membrane comprising a thin CNF layer with a thickness ranging between 50 and 80 nm on top of the microporous Lyocell scaffold with an average thickness of 130 ± 25 µm. As the top layer was due to the random agglomeration of CNF, its network formation rendered a pore structure with the size of around 50 nm. This pore size was effective to hinder the passage of uncharged PS nanoparticles with 50 nm diameter, where the PS beads were accumulated on top of the CNF layer due to size exclusion (FIGS. 4G and 4H). The intact structure of the CNF layer was also verified by the high rejection ratio (> 92%) against the PS nanoparticles by the cellulose membranes.

### Example 3

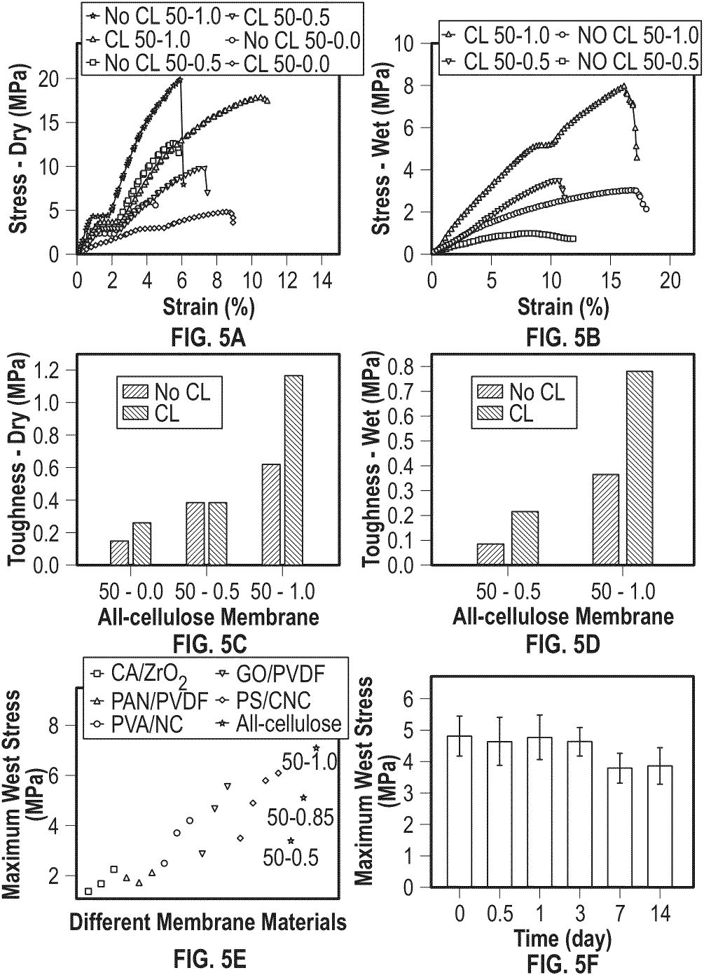

Tensile testing was performed in both dry and wet states to evaluate the effects of CNF content and PAE crosslinking on the mechanical properties of cellulose membranes. FIGS. 5A and 5B illustrate the typical dry and wet stress-strain curves of crosslinked and non-crosslinked cellulose membranes with different CNF loadings, respectively. All dry membranes showed a linear increase up to 3-5 MPa of the tensile stress, followed by a platform and then a continuous stress increment until failure occurred. The plateau in the stress-stress curve showed the plastic flow behavior of cellulose membrane due to the straightening and reorientation of the Lyocell fibrous scaffold and interfibrillar slippage. After the reinforcement behavior and following alignment of cellulose fibers, membrane failure occurred because of the failure of fibers and breakage between their existing bonds. The pure Lyocell membranes (50-0) exhibited no wet strength before or after crosslinking. Compared with the neat Lyocell membrane, the tensile stress of the cellulose membrane increased gradually with the increasing CNF loading. After chemical crosslinking, the covalent bond formation (ester bonds formed between the azetidinium groups in PAE and carboxyl groups in CNF) in the CNF network inhibited the interfibrillar detachment of the Lyocell scaffold in both dry and wet conditions.

It was noted that the crosslinking reaction slightly decreased the strength of the cellulose membrane but greatly enhanced the membrane toughness, especially in the wet state (FIGS. 5C and 5D). For example, the wet strength of the 50-1 cellulose membrane increased by 190% after the PAE crosslinking (from 2.8 ± 0.3 MPa to 8.1 ± 0.5 MPa), while the wet toughness of the crosslinked 50-1 membrane (0.78 MPa) became twice of the non-crosslinked 50-1 membrane (0.36 MPa).

The wet mechanical properties (i.e., the maximum stress in the stress-strain curve) of wet cellulose membranes and other reported membranes under the similar wet conditions are illustrated in FIG. 5E, while the maximum stress change of the crosslinked 50-0.85 (CL 50-0.85) membrane at varying water immersion time (up to 14 days) is shown in FIG. 5F. In FIG. 5E, it was seen that composite membranes without the incorporation of enhancing additives or physical/chemical crosslinking usually exhibited low mechanical properties. However, the cellulose membrane (CL 50-1.0) with a high loading of CNF crosslinked by PAE showed competitive maximum wet stress or wet strength in comparison with those from published composite membranes, confirming the potential of cellulose membranes for practical applications. In FIG. 5E, the wet strength of the cellulose membrane (CL 50-0.85) was found to decrease by about 20% after 7-day immersion probably because of the water-swollen effect, however this property remained unchanged at 3.8 ± 0.6 MPa for the rest of the test.

### Example 4

To test the UF performance of the cellulose membrane of Example 1 and commercial PVDF/PES membranes, activated sludge (or mixed liquor suspended solids “MLSS”) were collected from a membrane bioreactor in the Riverhead Sewage Treatment Plant, Long Island, NY and used as to test the membrane performance.

The MLSS was stored at 5° C. before the filtration experiment. The separation efficiency and antifouling properties of a cellulose membrane of the present disclosure (crosslinked 50-0.85 membrane) and commercial PVDF-V6, PVDF-A6, and PES-LX membranes were evaluated by measuring the pure water flux (J_{w}), water flux in the presence of effluent (J_{P}), retention ratio of foulant (R) and flux recovery ratio (Fr) using a dead-end UF cell (Model HP4750X, Sterlitech Corporation, USA) with an effective membrane area (A) of 14.6 cm².

All membranes were first compacted using distilled water under 0.5 bar pressure until a stable permeation flux was reached. The compacted membrane module was placed in a sludge feed tank with a capacity of 40 L. Subsequently, the MLSS was added into the reservoir and fully stirred to start the fouling emulation. A negative pressure in the membrane module was generated by a vacuum pump, where the permeate from the wastewater was sucked through the connected channels into the collection flask. The permeate was collected continuously for 12 hours. In this test, the pressure was stabilized at 0.5 bar.

The flux value was recorded to monitor the flux decline at different time intervals at 0.5 ± 0.02 bar and 24 ± 2° C. The turbidity and TDS concentrations were measured by a turbidity meter (Thermo Scientific Orion AQ3010). Briefly, 20 mL weighted sample was filtered through a 0.45 µm membrane filter (Millipore Co., Bedford, MA, USA). Then, the TDS concentration (mg L⁻¹) was calculated by drying the filtrate at 105° C. overnight and then weighing the dried solids.

The dynamic UF test was performed to evaluate the filtration performance and fouling behavior of cellulose membranes using MLSS with an original turbidity of 537 ± 98 nephelometric turbidity unit (NTU) and total dissolved solids (TDS) of 890 ± 102 mg L⁻¹. In this study, commercial UF membranes (PVDF-V6, PVDF-A6, and PES-LX) with a similar pore size range and initial water flux (as those of cellulose membranes) were also selected to provide the benchmark values for comparison.

The membrane permeation flux (J) was calculated using the following equation with the unit of L m⁻² h⁻¹ (LMH):

$$J = \frac{V}{\left(A \times t\right)} \qquad \text{(1)}$$

where Vis the volume of the permeate passing through the membrane at time t, and A is the effective membrane area. The rejection ratio (Rₜ) was determined by measuring the turbidity and TDS concentration in wastewater (C₀) and permeate (Cₜ) as follows:

$${R}_{t} \left(\%\right) = \left(1 - \frac{C {}_{t}}{{C}_{0}}\right) \times 100 \qquad \text{(2)}$$

The flux recovery ratio (Fᵣ,_{w}) was evaluated after applying either hydraulic cleaning (rinsing the membrane for 30 seconds at a flow rate of 0.6 gpm) or NaClO cleaning (i.e., immersing the membrane in 0.05 wt% NaClO solution for 30 seconds followed by three rounds of rinsing with distilled water) using the following equation:

$${F}_{r , w} \left(\%\right) = \frac{{J}_{w , w}}{{J}_{w}} \times 100 \qquad \text{(3)}$$

where J_{w},_{w} is the pure water flux after hydraulic cleaning and J_{w} is the pure water flux prior to the membrane fouling.

The resistance-in-series model to measure fouling utilizes Darcy’s Law to characterize filtration resistance. The formulas are shown below.

$${R}_{t} = \frac{\text{Δ} P}{μ \times {J}_{w 1}} \qquad \text{(4)}$$

$${R}_{M} = \frac{\text{Δ} P}{μ \times J} \qquad \text{(5)}$$

$${R}_{M} + {R}_{P} = \frac{\text{Δ} P}{μ \times {J}_{w 2}} \qquad \text{(6)}$$

$${R}_{C} = {R}_{t} - \left({R}_{M} + {R}_{P}\right) \qquad \text{(7)}$$

where J is the last flux point of DI compaction, J_{w1} is the last flux point of the current wastewater run, J_{W2} is the first flux point of the next wastewater run, ΔP is transmembrane pressure, and µ is the viscosity of permeate.

This model accounts for three types of resistances (pore clogging, cake layer, and inherent membrane resistance), assigning each a quantitative variable. A fourth quantitative variable, R_{f} (total fouling resistance) is determined by summating the variables R_{c} and Rₚ. The percent of reversible (cake layer) and irreversible (pore clogging) fouling can be demonstrated by calculating the variables ratio R_{c}/R_{f} and Rₚ/R_{f}.

$${R}_{t} = {R}_{C} + {R}_{P} + {R}_{M} \qquad \text{(8)}$$

$${R}_{t} = {R}_{f} + {R}_{M} \qquad \text{(9)}$$

$${R}_{f} = {R}_{C} + {R}_{P} \qquad \text{(10)}$$

where Rₜ is total resistance, R_{c} is cake-layer induced resistance, Rₚ is pore clogging induced resistance, Rₘ is inherent membrane resistance and R_{f} is fouling resistance.

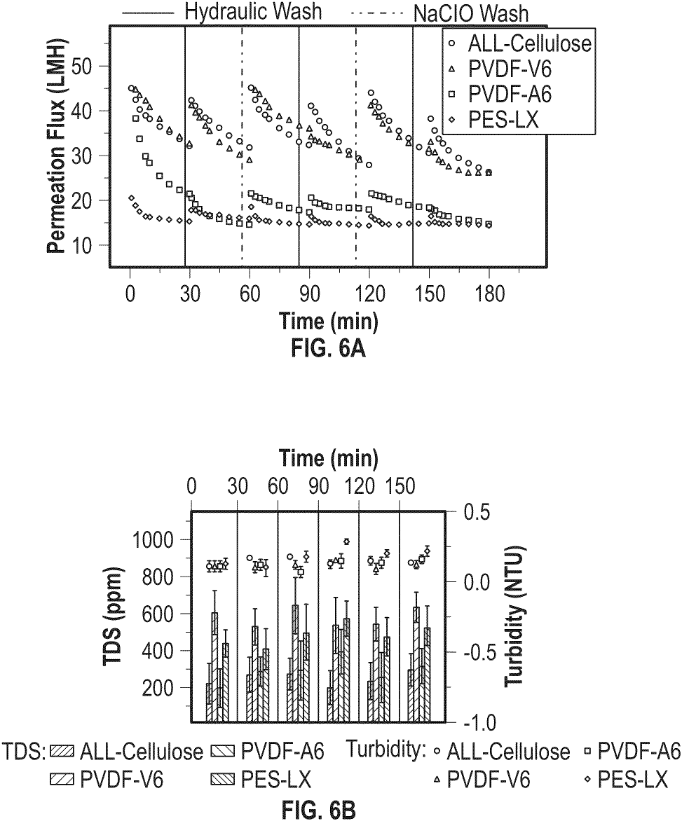

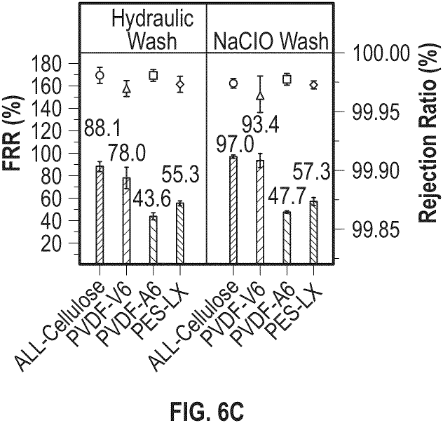

The results of the dynamic UF test are illustrated in FIGS. 6. As demonstrated in FIG. 6A, it was found that all membranes experienced a water flux decline over the filtration operation because of the fouling issue. However, the PVDF-A6 membrane displayed a steeper decrease than cellulose and PVDF-V6 membranes because of the hydrophobic nature of the PVDF-A6 membrane, resulting in a greater fouling tendency and flux decay. In contrast, the PES-LX membrane suffered the smallest flux decrease but it exhibited the lowest initial permeation flux. It was seen that the permeation flux of cellulose and PVDF-V6 membranes could be near fully recovered after hydraulic washing and NaClO cleaning, while hydrophobic membranes (PVDF-A6 and PES-LX) suffered irreversible fouling resulting poor flux recovery (below 23 LMH) after the first run. In this study, the turbidity of all tested permeates was below 0.3 NTU, which met the target requirement of 0.3 NTU for public water systems recommended by the United States Environmental Protection Agency (USEPA).

It is noteworthy to point out that, the permeate TDS by using the cellulose membrane was less than 400 ppm, lower than those of polymeric membranes (FIG. 6B). Although the rejection ratio of all tested membranes was above 99.9%, the recovery of permeation flux for these membranes using NaClO cleaning was slightly higher than that using hydraulic washing (FIG. 6C). The usage of NaClO to remove organic and microbial foulants, commonly absorbed on the membrane surface, is a well adopted approach to cleanse the used membrane in wastewater treatment. Among all tested membranes, the cellulose membrane (CL 50-0.85) exhibited the highest flux recovery ratio (88 ± 4.5% for hydraulic wash and 97 ±1.5% for NaClO cleaning). This indicates that the fouling layer developed on the cellulose membrane surface, which contains abundant hydrophilic hydroxyl and carboxyl groups, is easier to remove than those on the polymeric membrane surfaces either by water or NaClO cleaning.

### Example 5

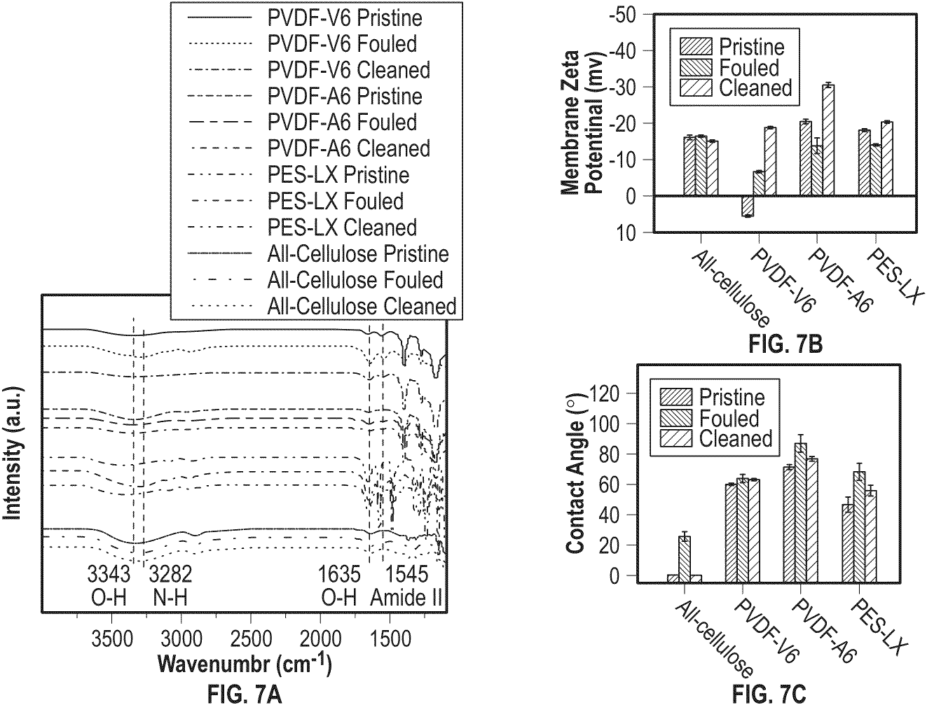

Soluble microbial products (SMP) and extracellular polymeric substances (EPS, the products of substrate metabolism and biomass decay) are major contributors to the membrane fouling problem in MBRs. These foulants consist of humic substances, proteins, lipids, polysaccharides, carbohydrates and macromolecules. FIG. 7A illustrates the surface characteristics, determined by FTIR spectra, of pristine, fouled, and cleaned cellulose (CL 50-0.85) of membranes of the present disclosure. The characteristic peaks of the foulants occurred mainly in the wavelength range of 1500-1800 cm⁻¹ and 3100-3400 cm⁻¹. Compared with the FTIR spectra of pristine membranes, the fouled membranes exhibited four new peaks at 1542 cm⁻¹ (C=N vibration of amide II), 1651 cm⁻¹ (C=O vibration of amide I and humics), 1731 cm⁻¹ (C=O vibration in protein), and 3282 cm⁻¹ (N-H stretching in protein and humic substance), which are characteristic peaks of protein and humic foulants. These results confirmed that membrane fouling was mainly caused by the C=O and C=N amide groups in protein molecules and the N-H groups in polysaccharides. It was seen that the cellulose membrane suffered a less tendency fouling, as revealed by the similar spectra from the pristine and fouled cellulose membranes. After NaClO cleaning, the difference in the spectra between all the pristine and cleaned cellulose membranes was negligible, indicating the high efficiency of NaClO in removing the organic and microbial foulants deposited on the cellulose surface.

To understand the detailed fouling process, other characterizations of the fouled and cleaned membranes were also carried out, including the contact angle measurement to determine the hydrophilicity and zeta potential measurements to determine the membrane surface charge, where the results from membranes being fouled by wastewater and being treated by NaCIO cleaning are shown in FIGS. 7B and 7C. In FIG. 7B, the contact angle (CA) of the pristine cellulose membrane (~ 0°) indicated that its surface was truly hydrophilic, whereas the polymeric membranes were relatively hydrophobic with higher CA values (50° - 70°). In comparison with the pristine membranes, the CA values of all fouled membranes became more hydrophobic due to the deposition of hydrophobic foulants on the membrane surface. After NaClO cleaning, only cellulose and PVDF-V6 membranes exhibited CA values close to their initial values. The CA value of the cleaned PVDF-A6 and PES membranes was somewhat higher than that of the membranes because of the presence of residual hydrophobic foulants on the membrane surface, even after the cleaning treatment.

The zeta potential test was also carried out to characterize the fouling behavior of the membranes, where the results could be used to optimize the membrane cleaning efficiency. As seen in FIG. 7B, the pristine cellulose (CL 50-0.85), PVDF-A6, PES-LX membranes typically exhibited negative zeta potential values. As the PVDF-V6 membrane contained modified-PVDF (described by the manufacturer) possibly with the amine groups (as seen by the N-H peak at 1560 cm⁻¹ in the FTIR spectrum, FIG. 7A), this membrane exhibited a positive zeta potential value at neutral pH. The negative zeta potential of the fouled PVDF-V6 membranes indicated the deposition of foulants such as biomacromolecules and hydrophobic organic matter in wastewater are all negatively charged. It was interesting to note that the pristine, fouled and cleaned cellulose membranes exhibited similar negative zeta potential values (FIG. 7B), which implied that only minor fouling occurred on the cellulose membrane surface.

### Example 6

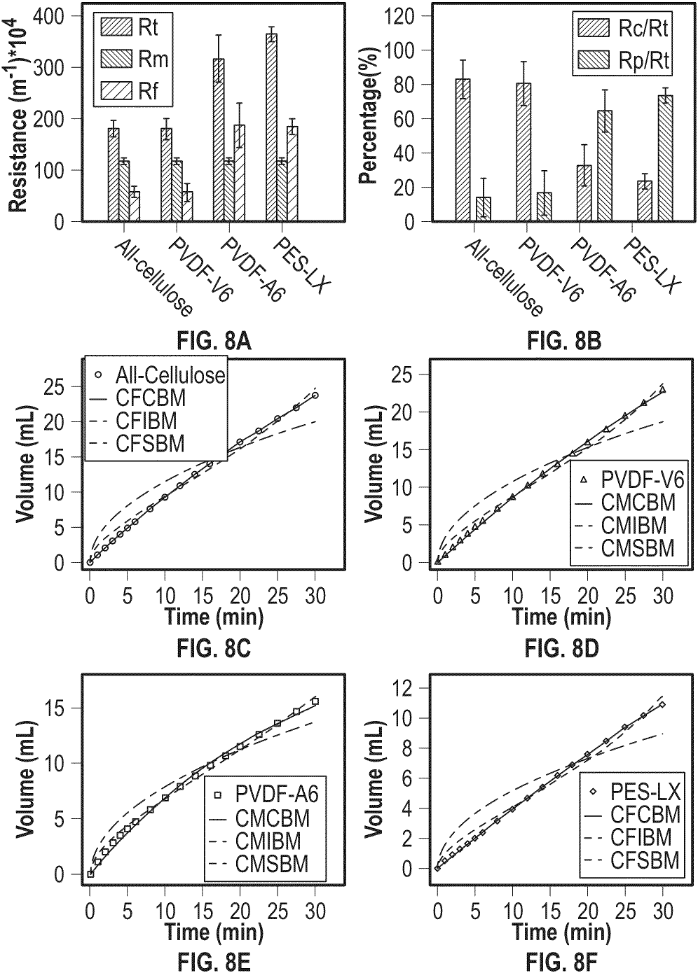

Fouling resistances parameters, such as total membrane resistance (Rₜ), intrinsic resistance (Rₘ) and fouling resistance (R_{f}), were characterized using a resistance-in-series model to reveal the mechanism of membrane fouling. The results are set forth in FIGS. 8. FIG. 8A is a summary of the total resistance (Rₜ), inherent membrane resistance (R_{M}) and fouling resistance (R_{f}), FIG. 8B shows the reversible fouling ratio (R_{c/}R_{f}) and irreversible fouling ratio (Rₚ/R_{f}) of cellulose and polymeric membranes during the flux recovery experiment of wastewater filtration. FIGS. 8C-8F show experimental and predictive permeation volume as a function of filtration time among different combined models of cellulose (CL 50-0.85), PVDF-V6, PVDF-A6, and PES-LX membranes. Bars are presented as mean ± SD of n=3 individual tests.

As illustrated in FIG. 8A, the cellulose membrane of the present disclosure and modified PVDF membrane (PVDF-V6) exhibited lower Rₜ and R_{f}, while the conventional PVDF-A6 and PES membranes showed more severe total fouling. Detailed analysis in FIG. 8B indicated that cellulose and modified PVDF membranes possessed a high reversible fouling percentage (R_{c/}R_{f}) and a low irreversible fouling percentage (Rₚ/R_{f}). This implied that the removable cake layer fouling dominated the total fouling during wastewater filtration.

To further understand the fouling mechanism during wastewater filtration, the accumulative permeate volume versus time data of cellulose (CL 50-0.85), PVDF (V6 and A6), and PES membranes was fitted with three combined models: cake filtration-complete blockage model (CFCBM), cake filtration-intermediate blockage model (CFIBM) and cake filtration-standard blockage model (CFSBM). The best fit was determined by comparing the difference between the data points and model’s prediction values, when the smallest sum of squared residuals (SSR) value was reached. As demonstrated in FIGS. 8C and 8F, the combined CFCBM was in good agreement with the experimental data for all tested membranes, regarding the lowest SSR and highest R² values. While the membrane encountered total resistance from both cake layer and complete pore blocking, the CFCBM model specified that the formation of foulant cake layer and complete membrane blocking could occur simultaneously rather than independently, as suggested by the single fouling model. While the rate of foulant precipitation on the membrane surface depended on the adjacent pore blockage, the rate of complete blocking was lower due to the resistance of foulant formation as a cake layer.

### Example 7

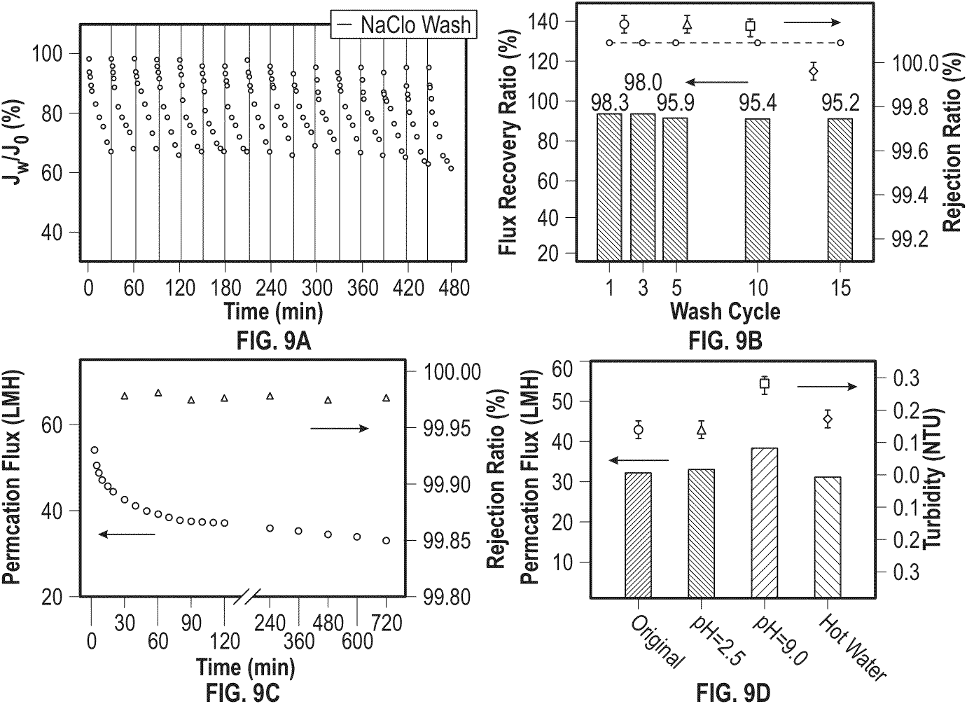

The unique features of the demonstrated cellulose membranes include good reproducibility and durability for the successful ultrafiltration process. For example, the normalized permeation flux (J_{w}/Jₒ) at the initial water flux (46.0 LMH) during 16 consecutive wastewater filtration runs was monitored (FIG. 9A) to illustrate the reproducibility of the representative cellulose membrane (CL 50-0.85). This membrane exhibited excellent flux recovery and easy to clean properties (e.g., using 30-second NaClO cleaning), as indicated by the high flux recovery ratio (> 95%) and high turbidity rejection ratio (> 99.95%) during the 16-cycle test run (FIG. 9B).

Furthermore, a 12-hour continuous wastewater filtration test was conducted to demonstrate the long-time stability of this cellulose membrane using an immersed membrane filtration system, which was commonly adopted in industrial membrane bioreactor. As the flux-time data displayed in FIG. 9C, the permeate flux declined from the initial value of 58.3 LMH to 37.2 LMH in the first two hours because of the simultaneous occurrence of cake layer fouling and pore blocking fouling. After 12-hour filtration under a constant pressure (0.5 bar), both high permeate flux (33 LMH) and good rejection ratio (>99.95%) were maintained. These results indicated good stability and durability of the demonstrated cellulose membrane and its excellent filtration efficiency under a lengthy operation cycle.

To evaluate this membrane for practical applications, the durability of the cellulose membrane (CL 50-0.85) was further evaluated at two different pH values (2.5 and 9.0) and elevated temperature (60° C.). As illustrated in FIG. 9D, the permeation flux of the cellulose membranes treated with acid and warm water was similar to the original membrane. As for the membrane immersed in a pH = 9.0 buffer, the permeation flux increased slightly because the cellulose component could degrade slowly under alkaline conditions. Regardless of the different treatment, the turbidity of all permeates maintained a low value (< 0.3 NTU), indicating that the cellulose membrane was relatively stable for use over a wide pH and temperature range.

### Example 8

To investigate the self-healing ability of selected membranes, the filtration performance of a scratched cellulose membrane produced in accordance with Example 1, as well as PVDF-V6, PES-LX, and PVDF-A6 membranes, was evaluated by distilled water using the dead-end filtration system. In this test, the membrane was first compressed with distilled water at pressure of 0.5 bar until the permeate flux was stable. A blade cutter was used to create a 3 cm scratch in the middle of membranes. The flux change was monitored before and after the scratch under the same filtration conditions.

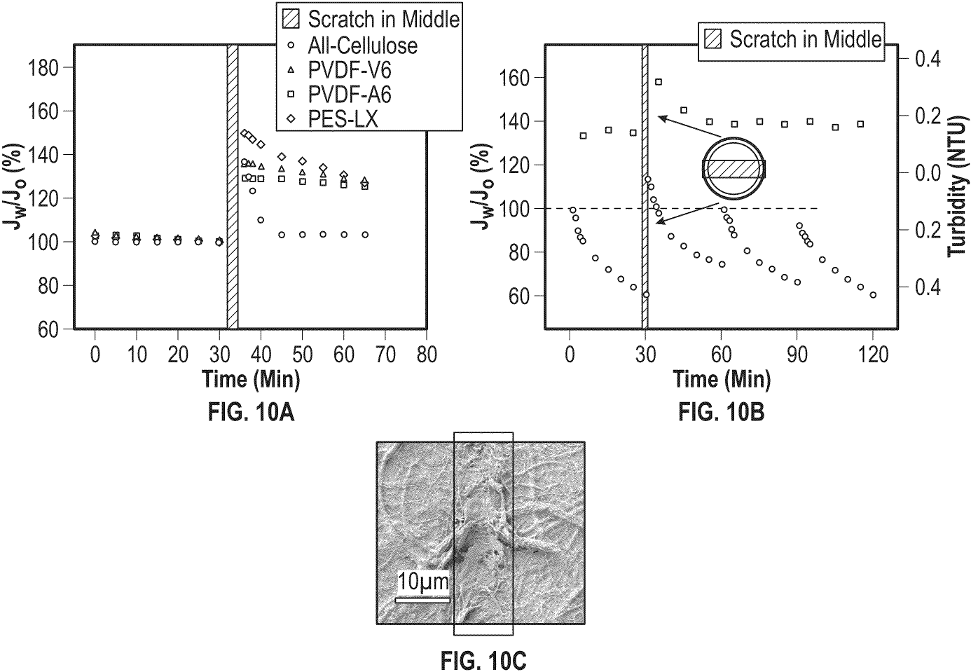

In the scratch test, the permeability of cellulose (CL 50-0.85) and polymeric membranes was evaluated prior to and immediately after the damage. After around 10-µm wide blade scratch was applied, the permeability of the cellulose membrane instantly increased to 135 ± 5% and then returned to 102 ± 3% of the starting permeability after a 10-minute distilled water run. On the other hand, the permeability of polymeric membranes surged after the scratch and could not drop back to the original values within the testing time (FIG. 10A). Furthermore, the wastewater filtration test of the scratched cellulose membrane exhibited the same trend observed in the distilled water run (FIGS. 10A and 10B). It was seen that after scratching, the permeate flux and turbidity of the cellulose membrane increased immediately and then gradually returned to the starting value in about 20 minutes during filtration. SEM images of the healed scratch on the used cellulose membrane verified its self-healing ability. The results indicated that cellulose nanofibers were able to form a new layer to cover the damage on the membrane surface.

As demonstrated by the above Examples, a robust and nanostructured cellulose membrane system with high porosity (~ 80%) was prepared by incorporating CNF into a Lyocell microfiber scaffold following by a crosslinking reaction among nanofibers. In the multiple-run wastewater filtration test, the optimized cellulose membrane exhibited high permeation flux (127.6 ± 21.8 L m-2 h-1 bar-1), excellent separation efficiency (> 99.9%), good flux recovery ratio (> 95%) and self-healing ability.

Compared with commercially available polymeric membranes, such as PVDF and PES membranes, the cellulose membrane of the present disclosure showed superior filtration performance after NaClO and pure hydraulic cleaning, as demonstrated by the FTIR, contact angle, and zeta potential characterizations. The commercially available polymer membranes suffered severe irreversible fouling during wastewater filtration. However, the cellulose membrane of the present disclosure demonstrated reversible fouling, which was revealed by the fouling mechanism study using the resistance-in-series model and three combined cake-filtration models.

In addition, the cellulose membranes of the present disclosure showed excellent flexibility, pH resistance, stability in hot water, and durability with good mechanical strength (the wet strength was 3.5 - 8.0 MPa). The easy to clean characteristics of the cellulose membrane could be attributed to the negative charges and hydrophilic membrane surface because of the presence of CNF. The sustainability, low cost, good mechanical strength, and filtration performance of cellulose membranes make them promising alternative for polymeric ultrafiltration membranes in wastewater treatments.

It will be understood that various modifications may be made to the embodiments disclosed herein. Therefore, the above description should not be construed as limiting, but merely as an exemplification of preferred embodiments. Those skilled in the art will envision other modifications within the scope and spirit of the present disclosure. Such modifications and variations are intended to come within the scope of the following claims.

What is claimed is:

1. A membrane system comprising:
a microfiber scaffold including cellulose; and
carboxylate-functionalized cellulose nanofibers.

2. The membrane system of claim 1, wherein the microfiber scaffold has a porosity from about 70% to about 90%.

3. The membrane system of claim 1, wherein the microfiber scaffold has a porosity from about 75% to about 85%.

4. The membrane system of claim 1, wherein the microfiber scaffold has a thickness from about 110 µm to about 160 µm.

5. The membrane system of claim 1, wherein the microfiber scaffold has a thickness from about 115 µm to about 155 µm.

6. The membrane system of claim 1, wherein the carboxylate-functionalized cellulose nanofibers are infused within the microfiber scaffold, the carboxylate-functionalized cellulose nanofibers are coated on the microfiber scaffold, or both.

7. The membrane system of claim 6, wherein the carboxylate-functionalized cellulose nanofibers are infused within the microfiber scaffold and coated on the microfiber scaffold.

8. The membrane system of claim 1, wherein the carboxylate-functionalized cellulose nanofibers are crosslinked with the microfiber scaffold.

9. The membrane system of claim 1, wherein the carboxylate-functionalized cellulose nanofibers are present in an amount from about 0.1% by weight to about 2.5% by weight of the membrane system.

10. The membrane system of claim 1, wherein the membrane system has a porosity from about 70% to about 90%.

11. The membrane system of claim 1, wherein the membrane system has a porosity from about 75% to about 85%.

12. The membrane system of claim 1, wherein the membrane system has a permeation flux from about 7.3 L m⁻² h⁻¹ bar⁻¹ to about 10.3 L m⁻² h⁻¹ bar⁻¹.

13. A method for filtering water, the method including contacting water with the membrane system of claim 1.

14. A method comprising:
combining a microfiber scaffold including cellulose with carboxylate-functionalized cellulose nanofibers to form a suspension;
mixing the suspension;
filtering the suspension to form a membrane;
recovering the membrane; and
contacting the membrane with a crosslinking agent,
wherein the carboxylate-functionalized cellulose nanofibers are crosslinked with the microfiber scaffold and the microfiber scaffold is infused with the carboxylate-functionalized cellulose nanofibers, coated with the carboxylate-functionalized cellulose nanofibers, or both.

15. The method of claim 14, wherein mixing the suspension occurs by stirring at a rate from about 700 rpm to about 1100 rpm for a period of time from about 15 minutes to about 45 minutes.

16. The method of claim 14, wherein filtering the suspension to form the membrane occurs by gravity filtration for a period from about 1 day to about 5 days.

17. The method of claim 14, wherein the crosslinking agent includes polyamideamine-epichlorohydrin.

18. The method of claim 14, wherein contacting the membrane with the crosslinking agent occurs by immersing the membrane in the crosslinking agent for a period of time from about 15 minutes to about 45 minutes.

19. The method of claim 14, further comprising, after contacting the membrane with the crosslinking agent, curing the membrane at a temperature from about 110° C. to about 130° C., for a period of time from about 15 minutes to about 45 minutes.

20. The method of claim 19, further comprising, after curing the membrane, washing the membrane with distilled water and then drying the membrane.
